(19) United States
(12) Patent Application Publication
(10) Pub. No.: US 2022/0187619 A1
(43) Pub. Date: Jun. 16, 2022

(54) COMBINED HAIR HEADBAND HAVING PIVOTALLY ATTACHED EYEGLASSES

(71) Applicant: Abraham Safdieh, New York, NY (US)

(72) Inventor: ABRAHAM SAFDIEH, New York, NY (US)

(21) Appl. No.: 17/121,891

(22) Filed: Dec. 15, 2020

(51) Int. Cl. G02C 3/02; A45D 8/36

(52) U.S. Cl. CPC G02C 3/02; A45D 8/36

(57) ABSTRACT

The present invention provides a combined hair headband having a pivotally attached eyeglass frame. The headband has a semi-circular shape for wearing on the head of the user and has a narrow headband member of less than one inch in width. The eyeglass frame has a pair of first and second gripping arms pivotally connected to the eyeglass frame. The end of the first gripping arm has a first attached pivot member connected to the first side of the headband member, so that the first gripping arm of the eyeglass frame is pivotally moveable with respect to the first side of the headband member. Also, the end of the second gripping arm has a second attached pivot member connected to the second side of the headband member, so that the second gripping arm of the eyeglass frame is pivotally moveable with respect to the second side of the headband member. The eyeglass frame may be heart shaped, or circular, or any other shape.

### FIELD OF THE INVENTION

The present invention relates to a combined narrow hair headband having a pair of eyeglasses pivotally attached to the arms of the headband.

### BACKGROUND OF THE INVENTION

The present invention is directed to different styles of eyeglasses or sunglasses, which have their side arms pivotally attached to the arms of a headband, so that the user can wear a combination of the hair headband, and pivot the attached eyeglass frame between a position of use and a position of non-use, when the eyeglass frame is pivoted upwardly onto the top of the head, when they are not in use.

### DESCRIPTION OF THE PRIOR ART

U.S. Patent App. Pub. No. 2010/0095977 to Paul Schmitz, et al. entitled “Hair Band With Retractable Eye Wear And Removable Decorative Cover” was published on Apr. 22, 2010, now abandoned. The '977 patent application discloses a hair band assembly and a pair of eyeglasses.

### OBJECTS OF THE INVENTION

It is an object of the present invention to provide the user with the combination of a hair headband, and a pivotally attached eyeglass frame.

Another object of the present invention is to provide a combined hair headband and eyeglass frame, which is moveable between a position of use or a position of non-use.

Another object of the present invention is to provide an eyeglass frame that may be pivoted upwardly onto the top of the head, when it is not in use.

Other objects of the present invention will become apparent from the following description.

### SUMMARY OF THE INVENTION

The present invention provides a combined hair headband having a pivotally attached eyeglass frame. The headband has a semi-circular shape for wearing on the head of the user and has a narrow headband member of less than one inch in width. The eyeglass frame has a pair of first and second gripping arms pivotally connected to the eyeglass frame. The end of the first gripping arm has a first attached pivot member connected to the first side of the headband member, so that the first gripping arm of the eyeglass frame is pivotally moveable with respect to the first side of the headband member. Also, the end of the second gripping arm has a second attached pivot member connected to the second side of the headband member, so that the second gripping arm of the eyeglass frame is pivotally moveable with respect to the second side of the headband member. The eyeglass frame may be heart shaped, or circular, or any other shape.

### BRIEF DESCRIPTION OF THE DRAWINGS

FIG. 1 is a perspective view of the combined hair headband and pivotally attached eyeglass frame;

FIG. 2 is a front perspective view thereof;

FIG. 3 is a front view thereof;

FIG. 4 is a rear view thereof;

FIG. 5 is left view thereof;

FIG. 6 is a top view thereof;

FIG. 7 is a bottom view thereof;

FIG. 8 is a perspective view of another style; and

FIG. 9 is a perspective view of another style.

### DETAILED DESCRIPTION OF THE PREFERRED EMBODIMENT

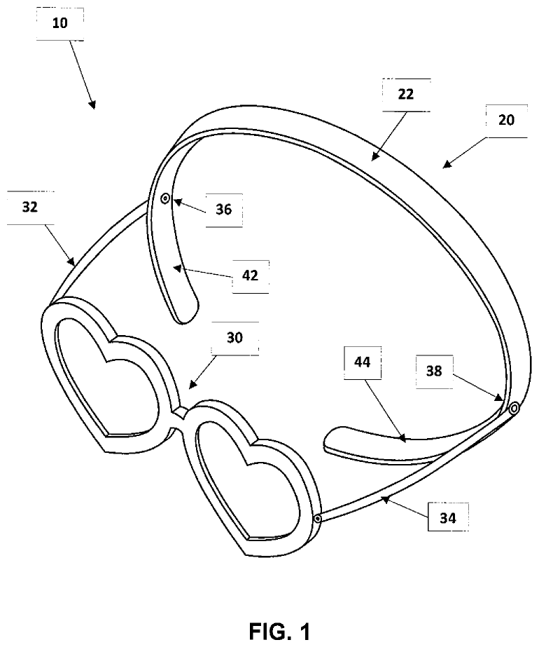

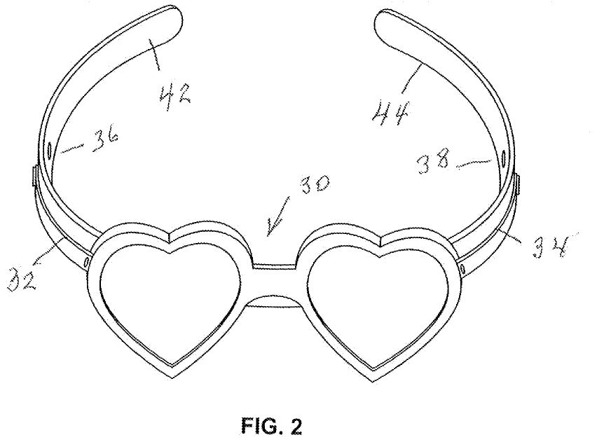

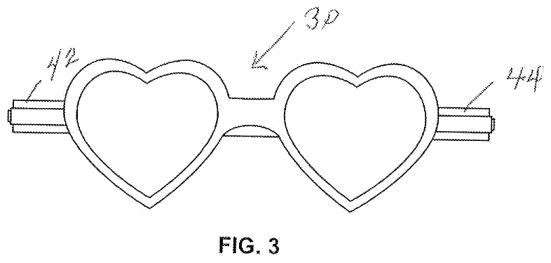

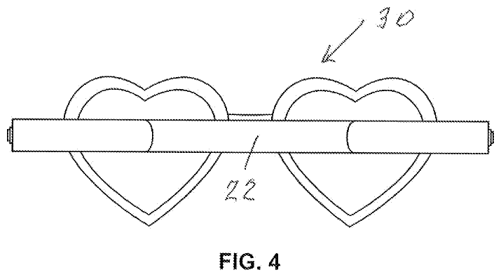

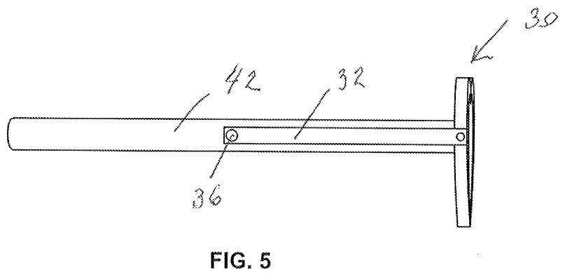

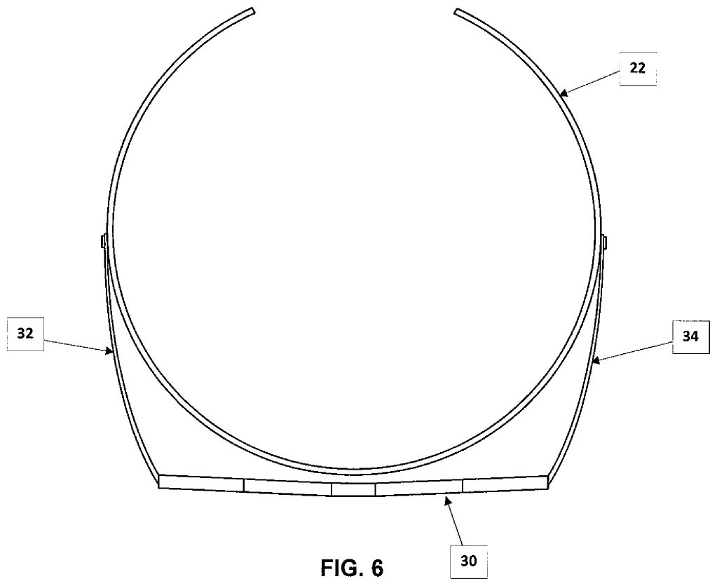

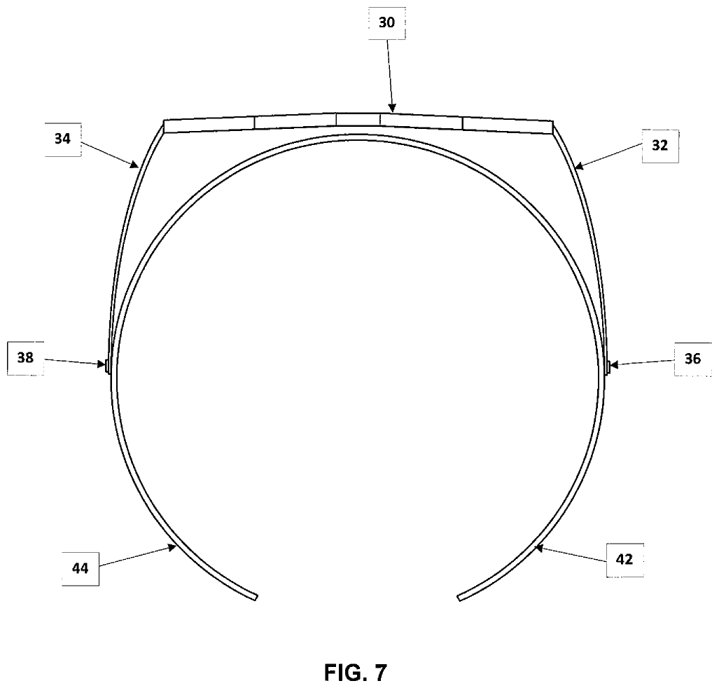

FIGS. 1 to 7 show a combined hair headband having a pivotally attached eyeglass frame 10. The headband 20 has a semi-circular shape for wearing on the head of the user and has a narrow headband member 22 of less than one inch in width. The eyeglass frame 30 has a pair of first and second gripping arms 32, 34 pivotally connected to the eyeglass frame 30. The end of the first gripping arm 32 has a first attached pivot member 36 connected to the first side 42 of the headband member 22, so that the first gripping arm 32 of the eyeglass frame 30 is pivotally moveable with respect to the first side of the headband member 40. Also, the end of the second gripping arm 34 has a second attached pivot member 38 connected to the second side 44 of the headband member 22, so that the second gripping arm 34 of the eyeglass frame 30 is pivotally moveable with respect to the second side 44 of the headband member 40. The eyeglass frame 10 may be heart shaped, or circular in shape, or any other shape.

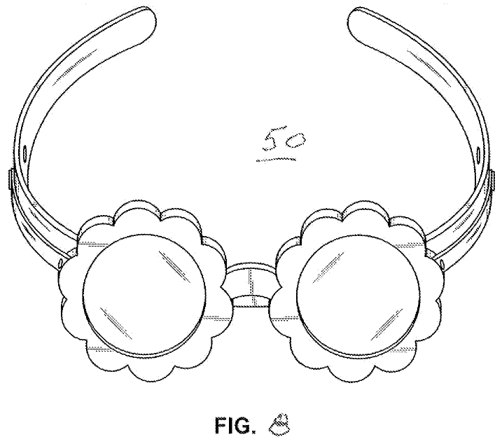

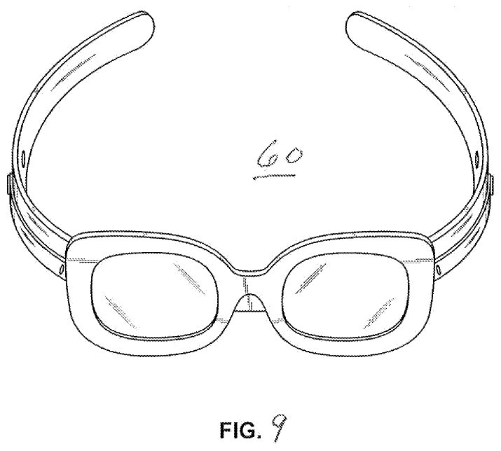

FIGS. 8 and 9 show additional embodiments of different styles of eyeglass frames 50 and 60.

### Advantages of the Present Invention

It is an advantage of the present invention to provide the user with the combination of a hair headband, and a pivotally attached eyeglass frame.

Another advantage of the present invention is to provide a combined hair headband and eyeglass frame, which is moveable between a position of use or a position of non-use.

Another advantage of the present invention is to provide an eyeglass frame that may be pivoted upwardly onto the top of the head, when it is not in use.

Other advantages of the present invention will become apparent from the description.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A combined hair headband having a pivotally attached eyeglass frame, comprising:
a. a semi-circular shaped hair headband for wearing on the head of the user having a narrow headband member of less than one inch in width;
b. a pair of eyeglasses having a pair of first and second gripping arms pivotally connected to said eyeglass frame;
c. the end of said first gripping arm having a first attached pivot member connected to the first side of said headband member, so that said first gripping arm of said eyeglass frame is pivotally moveable with respect to said first side of said headband member; and
d. the end of said second gripping arm having a second attached pivot member connected to the second side of said headband member, so that said second gripping arm of said eyeglass frame is pivotally moveable with respect to said second side of said headband member.

2. A combined hair headband in accordance with claim 1, wherein said hair headband is formed of plastic.

3. A combined hair headband in accordance with claim 1, wherein said first and second gripping arms of said eyeglass frame are formed of plastic.

4. A combined hair headband in accordance with claim 1, wherein said eyeglass frame has heart shaped circular eyeglass members.

5. A combined hair headband in accordance with claim 1, wherein said eyeglass frame has circular eyeglass members.

6. A combined hair headband in accordance with claim 1, wherein said eyeglass frame has wide frame eyeglass members.
